(19) United States
(12) Patent Application Publication
(10) Pub. No.: US 2024/0059577 A1
(43) Pub. Date: Feb. 22, 2024

(54) METHOD OF PREPARING ALUMINA

(71) Applicant: Alcoa of Australia Limited, Booragoon (AU)

(72) Inventor: Robert Joseph Lamacchia, Booragoon (AU)

(21) Appl. No.: 18/242,376

(22) Filed: Sep. 5, 2023

Related U.S. Application Data
(63) Continuation of application No. PCT/AU2022/050180, filed on Mar. 4, 2022.

(30) Foreign Application Priority Data
Mar. 4, 2022 (WO) PCT/AU2022/050180

(51) Int. Cl. C01F 7/306; B01D 9/00; C01F 7/62

(52) U.S. Cl. CPC C01F 7/306; B01D 9/0036; C01F 7/62; B01D 2009/0086; C01P 2006/80

(57) ABSTRACT

A process for preparing high purity alumina from aluminium-bearing materials is provided. The process digesting an aluminium bearing material to provide an aluminium chloride liquor, a first crystallisation vessel for crystallising aluminium chloride hexahydrate solids from the aluminium chloride liquor, optionally one or more subsequent crystallisation vessels for dissolving and recrystallising the aluminium chloride hexahydrate solids, and thermal treatment means for thermally treating the aluminium chloride hexahydrate solids to provide high purity alumina.

### TECHNICAL FIELD

The present disclosure relates to a method of preparing alumina, in particular to a method of preparing and purifying high purity alumina.

### BACKGROUND

High purity alumina is used in a broad range of technology applications, including use as a key material in high intensity discharge lamps, LEDs, sapphire glass for precision optics, handheld devices, television screens and watch faces, synthetic gemstones for lasers, components in the space and aeronautics industry and high strength ceramic tools. It may also be used in lithium ion batteries, acting as an electrical insulator between the anode and cathode cells. A high purity specification is particularly necessary in this latter application because any significant impurities would encourage undesirable electron transport between the cells.

High purity alumina may be made directly from aluminium metal by reacting a high purity aluminium metal with an acid to produce an aluminium salt solution, subsequently concentrating the solution and spray roasting the concentrated salt solution to provide aluminium oxide powder. This method is based on the premise of preparing the high purity alumina from a high purity aluminium feedstock to reduce potential for contamination with impurities.

Alternatively, alumina may be prepared from other feedstocks, however each feedstock presents a challenge to process to a suitable level of purity as a result of impurities present in the feedstocks.

Smelter or metallurgical grade alumina may be manufactured by direct calcination of aluminium hydroxide produced from bauxite by the Bayer process. However, these calcined grades of alumina may have soda content from 0.15-0.50%, which is too high for the applications discussed above.

Aluminous clays such as kaolin comprise aluminium oxide and a relatively high silicon content in the form of silicon oxide. During leaching of such aluminous clays, a number of impurities such as iron, titanium, calcium, sodium, potassium, magnesium, and phosphorus, which are found as oxides in the aluminous clay, are leached into solution along with the aluminium.

Thus, there is a need to develop alternative and more efficient processes for consistent preparation of high purity alumina from a variety of sources of aluminium.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

According to the present disclosure, there is provided a method of preparing high purity alumina from an aluminium chloride liquor, the method comprising:
providing an aluminium chloride liquor comprising aluminium chloride and one or more impurities in solution;
precipitating aluminium chloride hexahydrate solids from the aluminium chloride liquor in one or more crystallisation stage(s), wherein precipitating comprises sparging the liquor with hydrogen chloride gas, such that at least a portion of the one or more impurities remains in the liquor, wherein precipitating aluminium chloride hexahydrate solids further comprises seeding the aluminium chloride liquor in at least one of said crystallisation stage(s);
separating the aluminium chloride hexahydrate solids and the liquor from the one or more crystallisation stage(s); and
processing the separated aluminium chloride hexahydrate solids to form high purity alumina.

According to the present disclosure, there is further provided a high purity alumina prepared by a method according to any aspects, embodiments or examples thereof as disclosed herein.

According to the present disclosure, there is further provided a system for preparing high purity alumina from an aluminium bearing material comprising one or more impurities, the system comprising:
an acid digester for digesting the aluminium bearing material to provide an aluminium chloride liquor comprising one or more impurities;
a first crystallisation vessel for receiving the aluminium chloride liquor from the acid digester, and for precipitating aluminium chloride hexahydrate solids by sparging the liquor with hydrogen chloride gas, such that at least a portion of the one or more impurities remains in the liquor, and by seeding the aluminium chloride liquor;
optionally one or more subsequent crystallisation vessels for recrystallising the aluminium chloride hexahydrate solids; and
separation means associated with each crystallisation vessel for separating formed aluminium chloride hexahydrate from the remaining liquor
thermal treatment means for thermally treating the aluminium chloride hexahydrate solids to provide high purity alumina.

### BRIEF DESCRIPTION OF DRAWINGS

Preferred embodiments will now be further described and illustrated, by way of example only, with reference to the accompanying drawing in which:

FIG. 1 is a representative flow sheet of an embodiment of the method of preparing high purity alumina; and

FIGS. 2A-2F provides comparative data on impurity levels for unseeded and seeded precipitation of aluminium chloride hexahydrate.

### DESCRIPTION OF EMBODIMENTS

The present disclosure relates to a method of producing high purity alumina.

### General Terms

Throughout this specification, unless specifically stated otherwise or the context requires otherwise, reference to a single step, composition of matter, group of steps or group of compositions of matter shall be taken to encompass one and a plurality (i.e. one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Each example of the present disclosure described herein is to be applied mutatis mutandis to each and every other example unless specifically stated otherwise. The present disclosure is not to be limited in scope by the specific examples described herein, which are intended for the purpose of exemplification only. Functionally-equivalent products, compositions and methods are clearly within the scope of the disclosure as described herein.

The term “and/or”, e.g., “X and/or Y” shall be understood to mean either “X and Y” or “X or Y” and shall be taken to provide explicit support for both meanings or for either meaning.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the present specification, including definitions, will control. In addition, the materials, methods, and examples are illustrative only and not intended to be limiting.

The term “about” as used herein means within 5%, and more preferably within 1%, of a given value or range. For example, “about 3.7%” means from 3.5 to 3.9%, preferably from 3.66 to 3.74%. When the term “about” is associated with a range of values, e.g., “about X % to Y %”, the term “about” is intended to modify both the lower (X) and upper (Y) values of the recited range. For example, “about 20% to 40%” is equivalent to “about 20% to about 40%”.

### SPECIFIC TERMS

The term “alumina” as used herein refers to aluminium oxide (Al₂O₃), in particular the crystalline polymorphic phases α, γ, θ and κ. High purity alumina refers to Al₂O₃ with a purity of about 99.99%, e.g. a purity of >99.99% (4N) or a purity of >99.999% (5N) suitable for use as a key material in various applications including, but not limited to, high intensity discharge lamps, LEDs, sapphire glass for precision optics, handheld devices, television screens and watch faces, synthetic gemstones for lasers, components in the space and aeronautics industry, high strength ceramic tools, or electrical insulators in lithium ion batteries.

The term ‘aluminium-bearing material’ as used herein refers to any material with a greater than 10% content (by wt % eq. Al₂O₃). Examples of such aluminium-bearing materials include, but are not limited to, an acid-soluble aluminium hydroxide compound such as gibbsite (γ-Al(OH)₃), bayerite (α-Al(OH)₃), nordstrandite, doyleite or dawsonite (NaAl(OH)₂.CO₃), an acid-soluble aluminium oxyhydroxide compound such as diaspore (α-AlO(OH)) or boehmite (γ-AlO(OH)), tricalcium aluminate hexahydrate (TCA), or Al-substituted iron hydroxy oxide such as aluminous goethite (Fe(Al)OOH). The term encompasses naturally occurring materials, for example aluminous clays such as kaolin, or products or by-products of processes. As an example, the aluminium-bearing material may be a by-product of alumina production originating from the Bayer process such as calciner dust, DSP and red mud which typically have an aluminium content of >10 wt % (equiv. Al₂O₃).

As used herein, crystallisation refers to the precipitation of a solid material (the precipitate) from a liquid solution. Precipitation of the solid material occurs by converting the material into an insoluble form and/or changing the properties of the solution to reduce the solubility of the material.

The calcination of aluminium hydroxide in alumina production creates fine particulates which can be emitted as calciner dust. Calciner dust emissions may be mitigated and controlled to low levels by the use of various collection techniques such as electrostatic precipitators on the calciner stacks. ESP dust is the fine particulate residue captured by electrostatic precipitators. Calciner dust particles may comprise alumina and various aluminium (oxy)hydroxide and aluminium hydroxide compounds contaminated with occluded and surface soda.

DSP is a collective term used to describe several acid-soluble silica containing compounds which precipitate within the Bayer process. DSP is mainly Bayer-sodalite having a general formula of [NaAlSiO₄]₆.mNa₂X.nH₂O, in which “mNa₂X” represents the included sodium salt intercalated within the cage structure of the zeolite and X may be carbonate (CO₃²⁻), sulfate (SO₄²⁻), chloride (Cl⁻), aluminate (AlO₄)⁻). DSP forms in the ‘desilication’ circuit of the Bayer process prior to digestion circuit and also in the digestion circuit itself. DSP ultimately becomes part of bauxite residues (e.g. red mud). Further, it will be appreciated by those skilled in the art that silica may be supersaturated in solution throughout the Bayer process, despite reducing silica content in the desilication circuit. Consequently, DSP may also form as scale on the internal surfaces of tanks, pipes and heaters.

The term ‘soda’ and ‘soda content’ as used herein refers to Na₂O and the amount of Na₂O present in a material, reported as a percentage by weight (wt %) per total weight of the material. It will be appreciated that the soda content of high purity alumina must be low. A reference to ‘surface soda’ relates to the presence of adsorbed Na₂O on the surface of a particle, while a reference to ‘occluded soda’ relates to soda encapsulated in another material.

Calcination is a thermal treatment process in which solids are heated in the absence of, or controlled supply of, air or oxygen, generally resulting in the decomposition of the solids to remove carbon dioxide, water of crystallisation or volatiles, or to effect a phase transformation, such as the conversion of aluminium hydroxide to alumina. Such thermal treatment processes may be carried out in furnaces or reactors, such as shaft furnaces, rotary kilns, multiple hearth furnaces and fluidized bed reactors.

The term ‘atmospheric boiling point’ is used to refer to the temperature at which a liquid or slurry boils at atmospheric pressure. It will be appreciated that the boiling point may also vary according to the various solutes in the liquid or slurry and their concentration.

### Process for Preparing High Purity Alumina

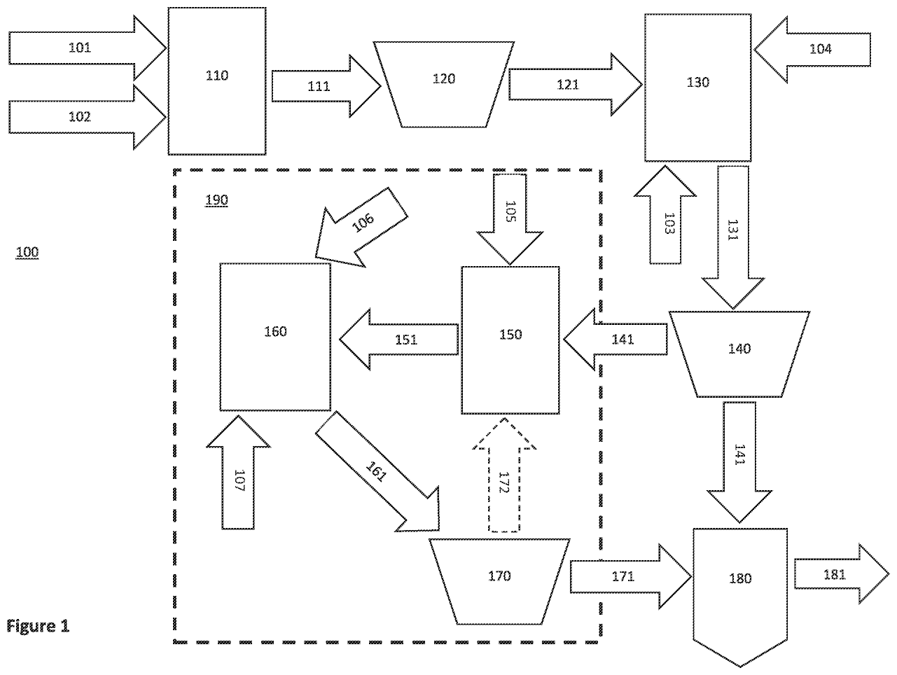

With reference to FIG. 1, according to the present disclosure there is provided a process and system for preparing high purity alumina from an aluminium-bearing material comprising one or more impurities. The system (100) comprises an acid digester (110) for digesting an aluminium-bearing material (102) to provide an aluminium chloride liquor (121), a first crystallisation vessel (130) for receiving the aluminium chloride liquor (121) from the acid digester (110), and for precipitating aluminium chloride hexahydrate (131) solids by sparging the liquor with hydrogen chloride gas (103), such that at least a portion of the one or more impurities remains in the liquor, and by seeding (104) the aluminium chloride liquor, optionally one or more subsequent crystallisation vessels (160) recrystallising the aluminium chloride hexahydrate solids, separation means (140, 170) associated with each crystallisation vessel (130, 160) for separating formed aluminium chloride hexahydrate (141, 142, 171) from the remaining liquor; and thermal treatment means (180) for thermally treating the aluminium chloride hexahydrate solids (141, 171) to provide high purity alumina (181).

Crystallisation of aluminium chloride hexahydrate Solids from an aluminium chloride Liquor

High purity alumina (181) may be prepared from various aluminium-bearing materials (102) for example aluminous clays such as kaolin, or products or by-products of processes such as the Bayer process. Many of these materials, however, have a high impurity content relative to the high purity threshold (about 99.99%) of the final desired product. Removal or control of the impurities to achieve the high purity threshold is technically difficult.

As will be described in further detail below, the aluminium-bearing material (102) may undergo a number of pre-treatment and treatment steps in order to form an aluminium chloride liquor comprising aluminium chloride and one or more impurities in solution.

The type and levels of impurities throughout the described process will depend on a number of factors, primarily the source of the aluminium-bearing material (102), although it will be appreciated that, while the described process steps aim to provide reduction in the levels of impurities at each step, new impurities may be introduced during the various process steps undertaken in the production of the high purity alumina (181).

The term ‘impurity’ or ‘impurities’ is intended to cover any non-aluminium compounds present. In particular, with regard to the final product, the ‘impurity’ or ‘impurities’ denote any material that is not aluminium oxide (Al₂O₃). The grade of the high purity alumina is based on total levels of impurities (regardless of composition) in the final product, with a product having a purity of >99.99% Al₂O₃ (i.e. less than 0.01% impurities) being graded “4N” and a purity of >99.999% Al₂O₃ (i.e. less than 0.001% impurities) graded “5N”.

By way of non-limiting example, the at least one impurity may be calcium (Ca), iron (Fe), potassium (K), magnesium (Mg), sodium (Na), phosphorous (P), silicon (Si), titanium (Ti), copper (Cu), molybdenum (Mo), chromium (Cr), gallium (Ga), zinc (Zn) or a combination thereof. In one example, the impurity is provided by one or more of calcium (Ca), iron (Fe), potassium (K), magnesium (Mg), sodium (Na), phosphorous (P), silicon (Si), titanium (Ti), copper (Cu), molybdenum (Mo), chromium (Cr), gallium (Ga), and zinc (Zn).

The individual or total impurity in the final product may be less than about 1000 ppm, 500 ppm, 400 ppm, 300 ppm, 200 ppm, 100 ppm, 90 ppm, 80 ppm, 70 ppm, 60 ppm, 50 ppm, 40 ppm, 30 ppm, 20 ppm, 10 ppm, or 5 ppm.

In one example, the impurity of any one impurity is less than about (in ppm) 50, 40, 30, 20, 10, 9, 8, 7, 6, 5, 4, 3, 2, or 1. In an example, the impurity of potassium (K) is less than about (in ppm) 50, 40, 30, 20, 10, 9, 8, 7, 6, 5, 4, 3, 2, or 1. In another example, the impurity of phosphorus (P) is less than about (in ppm) 50, 40, 30, 20, 10, 9, 8, 7, 6, 5, 4, 3, 2, or 1. In another example, the impurity of sodium (Na) is less than about (in ppm) 50, 40, 30, 20, 10, 9, 8, 7, 6, 5, 4, 3, 2, or 1. In another example, the impurity of silicon (Si) is less than about (in ppm) 50, 40, 30, 20, 10, 9, 8, 7, 6, 5, 4, 3, 2, or 1. In another example, the impurity of calcium (Ca) is less than about (in ppm) 50, 40, 30, 20, 10, 9, 8, 7, 6, 5, 4, 3, 2, or 1. In another example, the impurity of iron (Fe) is less than about (in ppm) 50, 40, 30, 20, 10, 9, 8, 7, 6, 5, 4, 3, 2, or 1. In another example, the impurity of magnesium (Mg) is less than about (in ppm) 50, 40, 30, 20, 10, 9, 8, 7, 6, 5, 4, 3, 2, or 1. In another example, the impurity of titanium (Ti) is less than about (in ppm) 50, 40, 30, 20, 10, 9, 8, 7, 6, 5, 4, 3, 2, or 1. In another example, the impurity of copper (Cu) is less than about (in ppm) 50, 40, 30, 20, 10, 9, 8, 7, 6, 5, 4, 3, 2, or 1. In another example, the impurity of molybdenum (Mo) is less than about (in ppm) 50, 40, 30, 20, 10, 9, 8, 7, 6, 5, 4, 3, 2, or 1. In another example, the impurity of chromium (Cr) is less than about (in ppm) 50, 40, 30, 20, 10, 9, 8, 7, 6, 5, 4, 3, 2, or 1. In another example, the impurity of gallium (Ga) is less than about (in ppm) 50, 40, 30, 20, 10, 9, 8, 7, 6, 5, 4, 3, 2, or 1. In another example, the impurity of zinc (Zn) is less than about (in ppm) 50, 40, 30, 20, 10, 9, 8, 7, 6, 5, 4, 3, 2, or 1.

The Al concentration in solution of the aluminium chloride liquor prior to crystallisation may be at least about 1 g/L, about 10 g/L, about 20 g/L, about 30 g/L, about 40 g/L, about 50 g/L, about 60 g/L, about 70 g/L, about 80 g/L, or about 90 g/L. The Al concentration in solution of the aluminium chloride liquor prior to crystallisation may be less than about 100 g/L, about 90 g/L, about 80 g/L, about 70 g/L, about 60 g/L, about 50 g/L, about 40 g/L, about 30 g/L, about 20 g/L, or about 10 g/L. In an embodiment, the Al concentration in solution of the aluminium chloride liquor prior to crystallisation may be in a range of between about 1-100 g/L, for example a range between any two of the above upper and/or lower concentrations, such as about 10-90 g/L, or 50-85 g/L, or about 60-80 g/L. To facilitate crystallisation, the Al concentration in the aluminium chloride liquor is preferably at or just below the saturation concentration for the solution.

With reference to the system (100) shown in FIG. 1, the aluminium-bearing material (102) is digested with hydrochloric acid (101) in acid digester (110). In the embodiment shown in FIG. 1, the digestion results in a slurry (111) comprising undigested solids and the aluminium chloride liquor (121) which may then be separated in separator (120). It will be appreciated, however, that if no solid materials remain after acid digestion, this separation step may not be required.

The prepared aluminium chloride liquor (121) comprising aluminium chloride and one or more impurities in solution undergoes a crystallisation stage in order to precipitate aluminium chloride hexahydrate solids (141) and leave behind at least a portion of the impurities in the liquor. It will be appreciated that the crystallisation in the first crystallisation vessel (130) may be performed in batch mode or a continuous mode. In addition, crystallisation may be performed in a single reactor (vessel) or a plurality of reactors arranged in series such that the concentration of precipitated aluminium chloride hexahydrate solids increases in each vessel.

In the crystallisation vessel (130), the chloride concentration in the liquor is raised to saturation concentration or above with respect to aluminium chloride hexahydrate, thereby encouraging aluminium chloride hexahydrate to precipitate from solution. For example, the initial chloride concentration may be raised to at least about 6 M. In another example, the initial chloride concentration may be raised to at least about 7 M, 8 M, 9 M, 10 M, or 11 M. The initial chloride concentration may be raised to provide less than about 12 M, 11 M, 10 M, 9 M, 8 M, or 7 M. The initial chloride concentration may be raised to provide an amount in a range between any two of these upper and lower amounts, such as between about 6 M to 12 M, 7 M to 11 M chloride, or 8 M to 10 M. In one particular example the initial chloride concentration is about 9 M.

The chloride concentration in the liquor can be readily raised by sparging with hydrogen chloride gas (103). In some embodiments, the chloride concentration is raised by continuous sparging with hydrogen chloride gas. Alternatively, the sparging may be periodically paused during the precipitation process. Sparging of the liquor may be paused after an initial portion of the hydrogen chloride gas has been introduced into the liquor, for example sparging may be paused after 50% of the hydrogen chloride gas has been introduced to the liquor. Advantageously, sparging with hydrogen chloride gas rather than a liquid can reduce the potential for contaminating the liquor with undesirable impurities.

It will be appreciated that the use of a plurality of reactors in series for precipitation, and therefore having smaller volumes of solution to be treated, may allow for an improved control of acid concentration, temperature and other precipitation conditions and therefore provide an improved control of the rate of crystallisation of aluminium chloride hexahydrate solids.

The corrosive nature of the hydrochloric acid and hydrogen chloride gas and the aluminium chloride liquor can lead to the introduction of impurities into the process through the corrosion of process equipment. As such, care is taken to ensure process equipment parts are where possible formed of materials inert to hydrochloric acid and hydrogen chloride gas and/or to protect the process equipment parts from acid attack.

The solids precipitation may be performed at a temperature of at least about (in ° C.) 25, 30, 35, 40, 45, 50, 55, 60, 65, 70, 75, 80, 85, 90, or 95. The solids precipitation may be performed at a temperature of less than about (in ° C.) 100, 95, 90, 85, 80, 75, 70, 65, 60, 55, 50, 45, 40, 35, or 30. The solids precipitation may be performed at a temperature between any two of these upper and lower amounts, such as between about 25° C. to 100° C., 30° C. to 90° C., or 40° C. to 80° C.

The solids precipitation may be performed for a period of at least about 1 hour, 2 hours, 3 hours, 4 hours, 5 hours, or 7 hours. The solids precipitation may be performed for a period of less than about 7 hours, 6 hours, 5 hours, 4 hours, 3 hours, or 2 hours. The solids precipitation may be performed for a period in a range provided by any two of the upper and/or lower amounts, such as from about 1 hour to 6 hours, or about 2 to 4 hours. In one particular example the period of time is about 3 hours.

The concentrated liquor may be seeded (104) to assist the kinetics of crystallisation and improve the purity of the resulting product. The composition of the seed (104) may be any suitable material for promoting crystallisation of aluminium chloride hexahydrate from the aluminium chloride liquor, for example the concentrated liquor may be seeded with an aluminium-bearing seed such as aluminium chloride hexahydrate or alumina crystals. The aluminium chloride hexahydrate or alumina crystals for seeding the crystallisation may be recycled from other stages of the process.

The aluminium chloride liquor may be seeded with aluminium chloride hexahydrate crystals in an amount of at least about 0.1 g/L, about 1 g/L, about 5 g/L, about 10 g/L, about 15 g/L, about 20 g/L, about 25 g/L, about 30 g/L, about 35 g/L, about 40 g/L, about 45 g/L, or about 50 g/L. The prepared aluminium chloride liquor may be seeded with aluminium chloride hexahydrate crystals in an amount of less than about 60 g/L, about 55 g/L, about 50 g/L, about 45 g/L, about 40 g/L, about 35 g/L, about 30 g/L, about 25 g/L, about 20 g/L, about 15 g/L, about 10 g/L, or about 5 g/L. The prepared aluminium chloride liquor may be seeded with aluminium chloride hexahydrate crystals in a range provided by any two of the upper and/or lower amounts, for example between about 0.1 g/L to 60 g/L, about 1 g/L to 50 g/L, or about 10 g/L to 55 g/L. In other examples, the range amount of seeded aluminium chloride hexahydrate crystals may be 0.1-1 g/L, 1-5 g/L, 5-10 g/L, 10-15 g/L, 15-20 g/L, 20-25 g/L, 25-30 g/L, 30-35 g/L, 35-40 g/L, 40-45 g/L, or 45-50 g/L. In other examples, these seeding amounts including ranges may be provided for other suitable seeding materials.

The seed (104) may be added to the aluminium chloride liquor prior to introduction to the crystallisation vessel (i.e. precipitation reactors) (130). In this step, additional soluble aluminium-bearing material may be added to the aluminium chloride liquor in order to increase the Al concentration to a desired level prior to seeding and crystallisation.

Where crystallisation (130) is performed in a plurality of reactors, one or more of the reactors may be seeded (104, 106) with the aluminium chloride hexahydrate crystals. In an embodiment, where crystallisation (130) is performed in a plurality of reactors in series, the liquor comprising precipitated aluminium chloride hexahydrate solids fed from one reactor to the subsequent reactor in the series may act to seed precipitation in the subsequent reactor. In one example, the first of the plurality of reactors may not be seeded and, as precipitation occurs as a result of the raised chloride levels from sparging, the aluminium chloride hexahydrate slurry flowing from the first reactor to a subsequent reactor carries a proportion of aluminium chloride hexahydrate solids that act to seed the subsequent reactor. Conditions in the series of reactors such as pH, sparging rate, outlet flow rate can be controlled to vary the rate of solids flowing from one reactor to the subsequent reactor, and to control the rate of crystallisation.

After precipitation, the liquor containing at least a portion of the impurities may then undergo a purification process to deplete the liquor of one or more impurities, in particular Ca, Fe, K, Mg, Na, P, Si, Ti, Cu, Mo, Cr, Ga and Zn. The separated liquor after precipitation may also undergo a purification process to recycle hydrochloric acid.

To further reduce the concentration of impurities, the precipitated aluminium chloride hexahydrate solids may optionally undergo one or more further purification and recrystallization steps (190) prior to thermal decomposition and calcination (180) to high purity alumina (181). For example, the precipitated aluminium chloride hexahydrate solids (105) may be digested in water (106) to form an aluminium chloride liquor (151) comprising aluminium chloride and any impurities remaining from the first crystallisation stage (130). This liquor can then undergo one or more additional crystallisations (160), including sparging (107) and seeding (106), in a manner as described above with respect to the first crystallisation stage (130) to produce precipitated aluminium chloride hexahydrate solids (171, 172), leaving further impurities behind in the remaining liquor.

It will be appreciated that the further purification and recrystallization steps (190) can be repeated as many times as necessary to arrive at a suitably pure aluminium chloride hexahydrate solids (171) prior to processing the solids to form high purity alumina (181). However, repeated digestion (150) and crystallisation (160) may not be required in those embodiments where the remaining impurities in the solids are sufficiently low such that the alumina which would be produced from thermal decomposition and calcination (180) of the solids collected after filtration would meet the purity requirements for high purity alumina.

Where multiple crystallisation stages are performed, seeding may be performed in some or all of the crystallisation stages, but need not be performed in all crystallisation stages. In an example, seeding may be performed in the first of the multiple crystallisation stages only to generate aluminium chloride hexahydrate solids while leaving the bulk of impurities present in the aluminium chloride liquor produced in the hydrochloric acid digestion of the aluminium-bearing material.

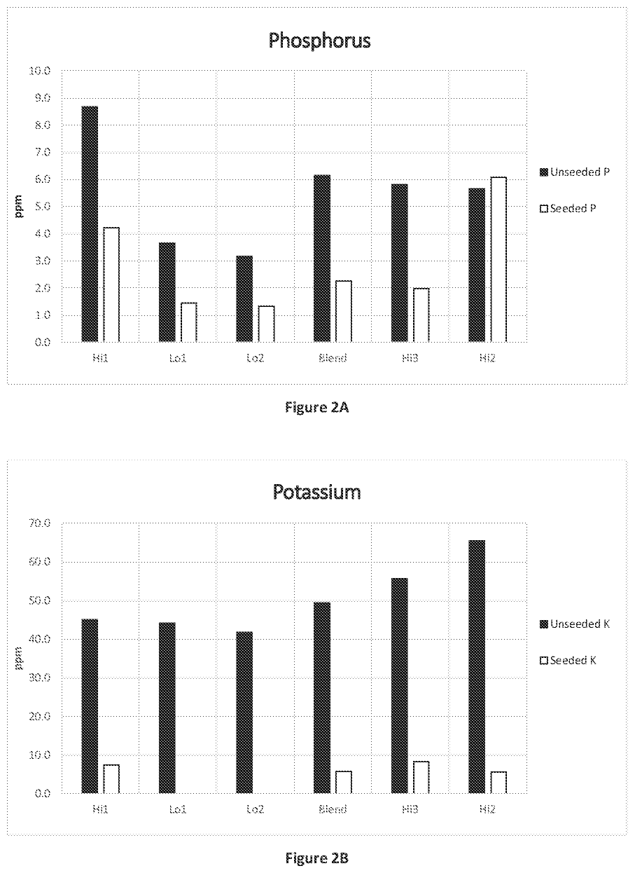

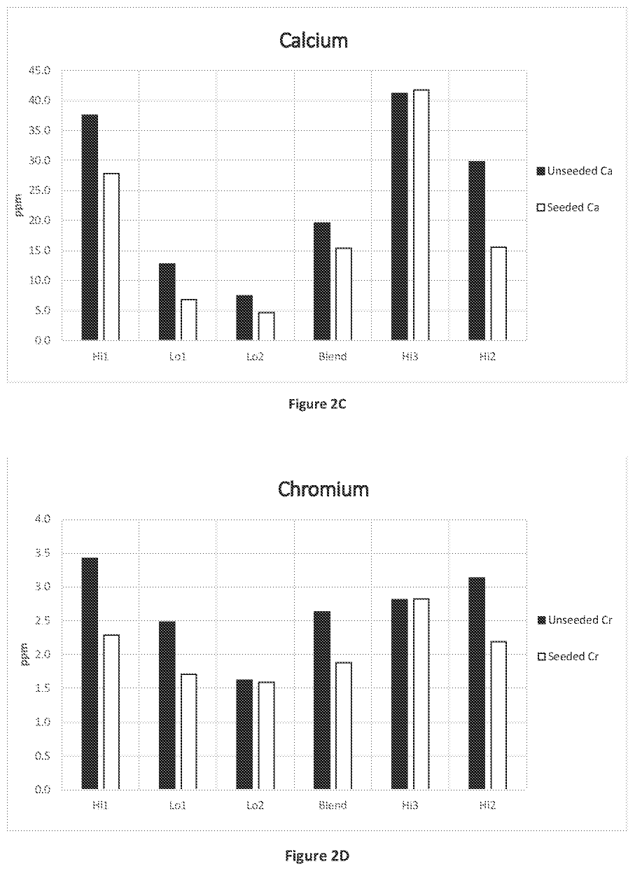

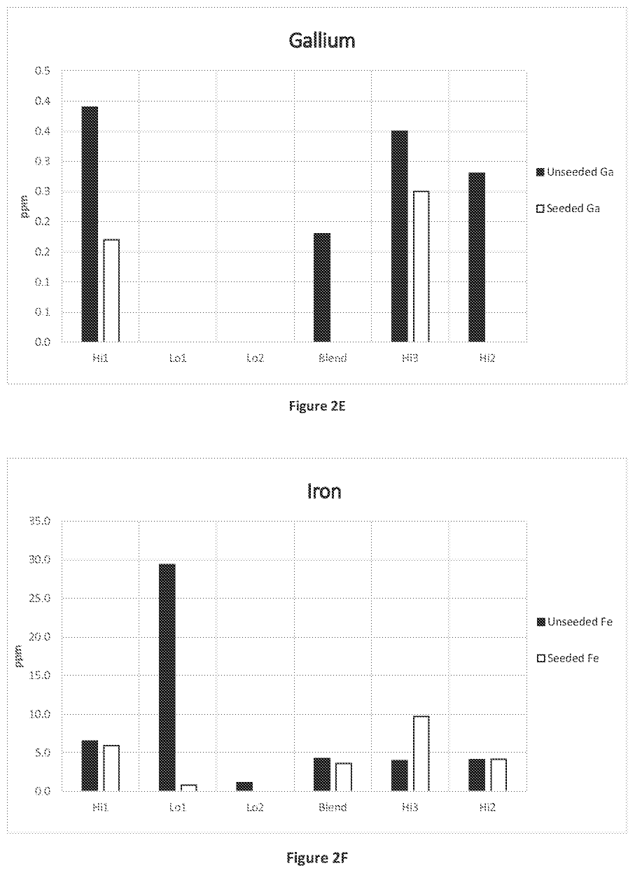

With regard to Example 2 and FIGS. 2A-2F described in more detail below, and in particular with reference to the results for solution “Hi3”, the benefits of seeding must be weighed against the potential introduction of further impurities into the precipitated aluminium chloride hexahydrate solids. Seeding in later crystallisation stages may be beneficial when seeking to reduce targeted impurities, for example potassium, in which there can be a significant additional reduction in concentration when seeding is used (see FIG. 2B).

In an embodiment, the aluminium-bearing seed comprises greater than 90%, 95%, 98%, or 99%, of aluminium compounds to minimise the introduction of impurities into the liquor. In another embodiment, the aluminium-bearing seed is an aluminium hexahydrate solid of greater than 90%, 95%, 98%, 99%, 99.9%, 99.99%, or 99.999% of aluminium hexahydrate solid to minimise the introduction of impurities into the liquor. In other examples the total amount of impurities in the aluminium bearing seed is less than 1%, 0.1%, 0.01%, 0.001%, or 0.0001%.

By way of non-limiting example, impurities present in the seed may include calcium (Ca), iron (Fe), potassium (K), magnesium (Mg), sodium (Na), phosphorous (P), silicon (Si), titanium (Ti), copper (Cu), molybdenum (Mo), chromium (Cr), gallium (Ga), zinc (Zn) or a combination thereof. In one example, the impurity is provided by one or more of calcium (Ca), iron (Fe), potassium (K), magnesium (Mg), sodium (Na), phosphorous (P), silicon (Si), titanium (Ti), copper (Cu), molybdenum (Mo), chromium (Cr), gallium (Ga), and zinc (Zn).

The individual or total impurity in the seed may be less than about 1000 ppm, 500 ppm, 400 ppm, 300 ppm, 200 ppm, 100 ppm, 90 ppm, 80 ppm, 70 ppm, 60 ppm, 50 ppm, 40 ppm, 30 ppm, 20 ppm, 10 ppm, or 5 ppm.

In one example, the impurity of any one impurity is less than about (in ppm) 50, 40, 30, 20, 10, 9, 8, 7, 6, 5, 4, 3, 2, or 1. In an example, the impurity of potassium (K) is less than about (in ppm) 50, 40, 30, 20, 10, 9, 8, 7, 6, 5, 4, 3, 2, or 1. In another example, the impurity of phosphorus (P) is less than about (in ppm) 50, 40, 30, 20, 10, 9, 8, 7, 6, 5, 4, 3, 2, or 1. In another example, the impurity of sodium (Na) is less than about (in ppm) 50, 40, 30, 20, 10, 9, 8, 7, 6, 5, 4, 3, 2, or 1. In another example, the impurity of silicon (Si) is less than about (in ppm) 50, 40, 30, 20, 10, 9, 8, 7, 6, 5, 4, 3, 2, or 1. In another example, the impurity of calcium (Ca) is less than about (in ppm) 50, 40, 30, 20, 10, 9, 8, 7, 6, 5, 4, 3, 2, or 1. In another example, the impurity of iron (Fe) is less than about (in ppm) 50, 40, 30, 20, 10, 9, 8, 7, 6, 5, 4, 3, 2, or 1. In another example, the impurity of magnesium (Mg) is less than about (in ppm) 50, 40, 30, 20, 10, 9, 8, 7, 6, 5, 4, 3, 2, or 1. In another example, the impurity of titanium (Ti) is less than about (in ppm) 50, 40, 30, 20, 10, 9, 8, 7, 6, 5, 4, 3, 2, or 1. In another example, the impurity of copper (Cu) is less than about (in ppm) 50, 40, 30, 20, 10, 9, 8, 7, 6, 5, 4, 3, 2, or 1. In another example, the impurity of molybdenum (Mo) is less than about (in ppm) 50, 40, 30, 20, 10, 9, 8, 7, 6, 5, 4, 3, 2, or 1. In another example, the impurity of chromium (Cr) is less than about (in ppm) 50, 40, 30, 20, 10, 9, 8, 7, 6, 5, 4, 3, 2, or 1. In another example, the impurity of gallium (Ga) is less than about (in ppm) 50, 40, 30, 20, 10, 9, 8, 7, 6, 5, 4, 3, 2, or 1. In another example, the impurity of zinc (Zn) is less than about (in ppm) 50, 40, 30, 20, 10, 9, 8, 7, 6, 5, 4, 3, 2, or 1.

In processes where multiple digestion and crystallisation stages are present, the operating conditions need not be the same in each stage and may be varied in response to the increasing purity of the product. In one example, as discussed above, the presence of seeding can be varied across crystallisation stages. Additionally, where seeding is provided in multiple crystallisation stages, the amount or type of seed may be varied for different stages, for example the amount of seed may be decreased for subsequent crystallisations.

In another example, the hydrochloric acid concentration may be varied for different crystallisation stages. While a higher hydrochloric acid concentration will increase the amount of aluminium chloride hexahydrate solids that precipitates from the liquor, this may also result in higher concentrations of impurities in the precipitated solids. Conversely, lower concentration may leave behind more aluminium in the liquor, however provide a more pure precipitate.

In an embodiment, the process comprises two or more crystallisation stages, in particular three crystallisation stages. The concentration of hydrochloric acid in the first crystallisation stage is lower than at least one of the subsequent crystallisation stages. For example, the concentration of hydrochloric acid in the first crystallisation stage may be less than about 10 M, 9 M, or 8 M, and the concentration of hydrochloric acid in at least one of the subsequent crystallisation stages may be greater than 11 M, 10 M, or 9 M, respectively. In another example, where three crystallisation stages are provided, the concentration of hydrochloric acid in the first crystallisation stage may be around 9 M, the hydrochloric acid concentration in the second crystallisation stage may be around 10.5 M and the hydrochloric acid concentration in the third crystallisation stage may be around 10 M.

In an embodiment, the or each crystallisation stage is performed in a plurality of reactors arranged in series. In such an embodiment, the concentration of hydrochloric acid may be progressively increased in the reactors in series to achieve a concentration in the final reactor in the series as described above.

Preparation of Aluminium Chloride Liquor from an Aluminium-Bearing Material

As-received aluminium-bearing materials may undergo one or more pre-treatment steps prior to undergoing digestion to form an aluminium chloride liquor.

Said pre-treatment step(s) may be any one or more beneficiation processes including, but is not limited to, concentration, gravity separation to deplete the material of gangue such as sand or quartz, or comminution to a particle size of 1 μm to 200 μm.

It will be appreciated that certain aluminium-bearing materials, such as calciner dust, may include occluded and surface soda. Prior to calciner dust entering the process circuit, surface soda may be readily removed from the calciner dust by scrubbing the calciner dust with carbon dioxide to remove surface soda as sodium bicarbonate. The scrubbed calciner dust may then be subsequently filtered and washed with water to remove residual sodium bicarbonate before entering the process circuit.

Alternatively, soluble surface soda may be at least partially removed from the calciner dust by washing with water. The washed calciner dust may then be subsequently filtered before entering the process circuit.

In an embodiment, gibbsite feed may be provided from a Bayer process circuit in which the gibbsite feed may have, optionally, been subjected to one or more recrystallization steps, such as from an alkali solution within the Bayer process circuit, thereby depleting the feed of one or more impurities, in particular soda.

In another embodiment, an aluminous clay feed such as kaolin may be provided.

The process for preparing high purity alumina may include digesting the aluminium-bearing material with hydrochloric acid to produce an aluminium chloride liquor. The hydrochloric acid may have a concentration of from 5 M to 12 M HCl, 6 to 11 M HCl, 6 to 10 M HCl, or 7 M to 9 M HCl.

The concentration of HCl of the resulting aluminium chloride liquor may range from 0 M to 2 M. For example the concentration of HCl of the resulting aluminium chloride liquor may be about 0 M, 0.5 M, 1 M, 1.5, M, or 2M. It will be appreciated that the digestion step may be performed in a batch mode or a continuous mode. The digestion step may be performed in a single reactor (vessel) or a plurality of reactors (e.g. up to 5 vessels, such as 3 vessels) arranged in series such that the concentration of HCl in the liquor in each vessel in the series decreases in cascading order from about 10 M to about 2 M.

The resulting mixture may have an initial solids content of up to 50% w/w, although it will be appreciated that the solids content of the mixture will decrease as digestion progresses.

The acid digestion may be performed at a temperature of from ambient temperature to atmospheric boiling point of the resulting aluminium chloride liquor. The acid digestion may be performed at a temperature of at least about (in ° C.) 25, 30, 35, 40, 45, 50, 55, 60, 65, 70, 75, 80, 85, 90, or 95. The acid digestion may be performed at a temperature of less than about (in ° C.) 100, 95, 90, 85, 80, 75, 70, 65, 60, 55, 50, 45, 40, 35, or 30. The acid digestion may be performed at a temperature between any two of these upper and lower amounts, such as between about 25° C. to 100° C., 50° C. to 95° C., 70° C. to 90° C., or 75° C. to 85° C., for example at about 80° C.

It will be appreciated that the rate of digestion will depend on the temperature, concentration of solids and acid concentration in the resulting digestion mixture. The acid digestion may be performed for a period of at least about 15 minutes, 1 hour, 2 hours, 3 hours, 4 hours, 5 hours, or 7 hours. The acid digestion may be performed for a period of less than about 7 hours, 6 hours, 5 hours, 4 hours, 3 hours, 2 hours, or 1 hour. The solids precipitation may be performed for a period in a range provided by any two of the upper and/or lower amounts, such as from about 15 minutes to 6 hours, or about 2 to 4 hours. In one particular example the period of time is about 3 hours.

After dissolution of the acid-soluble compounds is complete, the resulting aluminium chloride liquor is separated, where required, from any remaining solids by any suitable conventional separation technique, such as filtration, gravity separation, centrifugation and so forth. It will be appreciated that the solids may undergo one or more washings during separation.

The aluminium chloride liquor may undergo further pre-treatment prior to undergoing crystallisation to precipitate aluminium chloride hexahydrate solids, for example in the manner described above.

For example, one such pre-treatment may include contacting the aluminium chloride liquor with an ion exchange resin, in particular a cation exchange resin.

Alternatively, another example of such a pre-treatment may include contacting the aluminium chloride liquor with an adsorbent to adsorb the one or more impurities, optionally in combination with a complexing agent. Suitable adsorbents include, but are not limited to, activated alumina, silica gel, activated carbon, molecular sieve carbon, molecular sieve zeolites and polymeric adsorbents.

Yet another example of a pre-treatment may include selectively precipitating chloride salts of the one or more impurities. For example, the liquor may be cooled and sparged with HCl gas to encourage salting out of sodium chloride.

A further example of such a pre-treatment may include reacting the liquor with a complexing agent, wherein the complexing agent is capable of selectively forming a complex with one or more impurity. In this way, the complexed impurity may remain in solution when aluminium chloride hexahydrate solids are produced. The complexing agents may be selective for Na, Fe or Ti. Suitable complexing agents for Na include, but are not limited to, macrocyclic polyethers such as crown ethers, lariat crown ethers, and cryptands. Suitable crown ethers which demonstrate good selectivity for sodium include 15-crown 5, 12-crown 4 and 18-crown 6. Such crown ethers are soluble in aqueous solutions. Suitable complexing agents for Fe include, but are not limited to, polypyridyl ligands such as bipyridyl and terpyridyl ligands, polyazamacrocyles. Suitable complexing agents for Ti include, but are not limited to, macrocyclic ligands incorporating O, N, S, P or As donors. Other metal complexing agents may include heavy metal chelating agents such as EDTA, NTA, phosphonates, DPTA, IDS, DS, EDDS, GLDA, MGDA.

Still another example of such a pre-treatment may include solvent extraction. Suitable carriers may be non-polar solvents including, but not limited to, haloalkanes such as chloromethane, dichloromethane, chloroform, and long-chain alcohols such as 1-octanol. The crown ether complexing agents discussed above are generally more soluble in water than non-polar solvents. Accordingly, modification of the crown ether complexing agents discussed above by addition of hydrophobic groups such as benzo groups and long chain aliphatic functional groups may improve the partitioning of the crown ether complexing agent in the non-polar solvent.

In some embodiments wherein the impurity is sodium, the aluminium chloride liquor may be purified by passing it through a semi-permeable cation selective membrane, in particular a sodium selective membrane to separate sodium impurities from the liquor.

After undergoing any pre-treatments such as described above, the resulting aluminium chloride liquor may be concentrated in an evaporator to increase the Al concentration in solution. The Al concentration in solution of the aluminium chloride liquor after evaporation may be at least about 1 g/L, about 10 g/L, about 20 g/L, about 30 g/L, about 40 g/L, about 50 g/L, about 60 g/L, about 70 g/L, about 80 g/L, or about 90 g/L. The Al concentration in solution of the aluminium chloride liquor after evaporation may be less than about 100 g/L, about 90 g/L, about 80 g/L, about 70 g/L, about 60 g/L, about 50 g/L, about 40 g/L, about 30 g/L, about 20 g/L, or about 10 g/L. In an embodiment, the Al concentration in solution of the aluminium chloride liquor after evaporation may be in a range of between about 1-100 g/L, for example a range between any two of the above upper and/or lower concentrations, such as about 10-90 g/L, or 50-85 g/L, or about 60-80 g/L. To facilitate crystallisation, the Al concentration in the aluminium chloride liquor after evaporation is preferably at or just below the saturation concentration for the solution.

The concentrated liquor is then treated, for example in the manner described in detail above, in order to precipitate aluminium chloride hexahydrate solids from the aluminium chloride liquor.

Production of High Purity Alumina from Precipitated Chloride Hexahydrate Solids

After solids precipitation is complete, the resulting aluminium chloride hexahydrate solids are separated (140, 170) from the remaining liquor and washed with hydrochloric acid. Any suitable conventional separation technique, such as filtration, gravity separation, centrifugation, classification and so forth, may be used. It will be appreciated that the solids may undergo one or more washings during separation.

The separated liquor and combined washings may be conveniently recycled for use as a washing medium for filtration of aluminium chloride hexahydrate solids produced upstream. Alternatively or additionally, some or all of the separated and washed aluminium chloride hexahydrate solids may be used to seed one or more crystallisation process steps upstream.

The separated aluminium chloride hexahydrate solids may optionally be dissolved in water and the resulting solution subjected to a purification process. The further purification process may be any one of the purification processes as described above, and may be the same or a different process, depending on the target impurity which must be removed or the residual concentration of the remaining impurities in the solution.

The collected solids (141, 171) may then be heated to a first temperature from 200° C. to 900° C. to thermally decompose the solids. Hydrogen chloride gas is evolved during thermal decomposition and may be recycled for use in the production of aluminium chloride hexahydrate solids.

The decomposed solids are subsequently calcined (180) from 1000° C. to 1300° C. to produce high purity alumina. Any hydrogen chloride gas that may be evolved during calcination may be recycled for use in the production of aluminium chloride hexahydrate solids.

By control of the removal of impurities from the initial aluminium chloride liquor formed from the aluminium-bearing material and taking measures to reduce the inclusion of impurities in the aluminium chloride hexahydrate solids through the implementation of the steps according to the present disclosure such as, in particular, the use of seeding in one or more precipitation steps, and minimising the introduction of new impurities during the process steps, a higher purity alumina of greater than 99.99% purity (4N) or greater than 99.999% purity (5N) may be reliably achieved from a wide range of aluminium-bearing materials.

To assist in minimising the introduction of impurities during crystallisation, a portion of the formed high purity alumina may be optionally recycled to seed the aluminium chloride liquor in one or more precipitation steps upstream.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

### EXAMPLES

The following examples are to be understood as illustrative only. The following examples should therefore not be construed as limiting the embodiments of the disclosure in any way.

### Example 1—Modelling of 3× Precipitation Stage Process

On the basis of experimental data, modelling was conducted on the treatment of an aluminium hydroxide in accordance with a process according to FIG. 1 and having three precipitation stages.

The modelling was conducted on a method in accordance with the following conditions.

Digestions of aluminium containing material: Modelling was performed on the basis of the aluminium-containing material being digested in the a continuously stirred reactor in 9 M HCl at 80° C. with an average residence time of 3 hours; and the resulting slurry being separated from a clarified aluminium chloride liquor comprising aluminium chloride and a number of impurities in solution.

Precipitation steps: Modelling was performed on the basis of hydrogen chloride gas being bubbled through the clarified aluminium chloride liquor in a continuously stirred crystallisation vessel in order to precipitate aluminium chloride hexahydrate solids. The crystallisation vessel comprised three crystallisation tanks in series, with the HCl level increasing progressively to a concentration in the third tank at around 9 M and at a temperature of around 50° C. The resulting product stream being separated after which the separated aluminium chloride hexahydrate solids undergo second and third digestion/crystallisation processes, with the HCl level modelled at around 10.5 M in the third tank of the second crystallisation vessel and at around 10 M in the third tank of the third crystallisation vessel.

The modelled purity of the resulting aluminium chloride hexahydrate solids after each of the three crystallisation vessels with regard to a number of impurities is summarised in Table 1 below.

TABLE 1
Modelling of the purity of ACH in a 3 precipitation stage process

| | Exit stream | | |
|---|---|---|---|
| | ACH | ACH | ACH |
| | 1^{st} | 2^{nd} | 3^{rd} |
| Purity | Precipitation | Precipitation | Precipitation |
| ACH purity (%) | 99.9988 | 99.9999 | 100.0000 |
| Calcium (ppm) | 0.6435 | 0.0235 | 0.0002 |
| Iron (ppm) | 0.0468 | 0.0010 | 0.0000 |
| Potassium (ppm) | 0.0349 | 0.0008 | 0.0000 |
| Magnesium (ppm) | 0.0214 | 0.0011 | 0.0000 |
| Sodium (ppm) | 11.61 | 0.6382 | 0.0103 |
| Phosphorus (ppm) | 0.0004 | 0.0000 | 0.0000 |
| Silicon (ppm) | 0.0047 | 0.0001 | 0.0000 |

### Example 2—Effect of Seeding on Impurity Removal

An AlCl₃ solution was prepared by digesting an aluminium-bearing material in hydrochloric acid. From the AlCl₃ solution, solutions of low impurity level (Lo1, Lo2), high impurity level (Hi1, Hi2, Hi3) and an intermediate impurity level (Blend) were prepared.

The solution was placed in a jacketed round bottomed flask controlled to a temperature between 40 to 60° C. The precipitation of aluminium chloride hexahydrate solids was performed by sparging the solution with HCl gas. The HCl gas was produced by placing a volume of hydrochloric acid in an acid dropper that provided hydrochloric acid into a stirred solution of concentrated sulfuric acid. The liberated HCl gas was combined with a nitrogen carrier gas and bubbled through the solution in the round bottomed flask.

In the seeded experiments, the starting solution was also seeded with aluminium chloride hexahydrate at 5, 22.5 or 40 g/L. The conditions of the seeded experiments are summarised in Table 2 below.

TABLE 2
Summary of reaction conditions for seeded precipitation

| | | Finish acid | Seed |
|---|---|---|---|
| | Temperature | concentration | concentration |
| | (° C.) | (mol HCl/L) | (g/L) |
| Hi1 | 40.00 | 7.54 | 5.00 |
| Lo1 | 40.00 | 9.75 | 5.00 |
| Lo2 | 60.00 | 8.64 | 5.00 |
| Blend | 50.00 | 9.30 | 22.50 |
| Hi3 | 40.00 | 10.33 | 40.00 |
| Hi2 | 60.00 | 7.91 | 5.00 |

The resulting levels of the impurities phosphorus, potassium, calcium, chromium and gallium from the seeded precipitations in comparison to unseeded precipitation performed under similar experimental conditions is set out in FIGS. 2A-2F.

As is demonstrated in FIGS. 2A-2F, seeded precipitation typically resulted in a lower level of impurity inclusion than unseeded precipitation. While for some impurities, the final concentration was similar for seeded and unseeded precipitations, it will be appreciated that such reductions are necessary to arrive at the high purity levels required for 4N (i.e. a purity of >99.99%) or 5N (i.e. a purity of >99.999%) high purity alumina.

It will be appreciated that impurities may be introduced to the product through the seed. Where seeding rates are high, the impurity levels in the final product may be a function more of the impurity levels in the seed as opposed to the impurities included in the newly precipitated product. For certain impurities, and dependent on the amount of seed added, the levels introduced with the seed may result in levels of these specific impurities that are greater than observed in the corresponding unseeded system. For example, this was observed with regard to calcium (FIG. 2C), chromium (FIG. 2D) and iron (FIG. 2F) for the tests seeded at the highest seeding rate (40 g/L). Seeding rates and the purity of seed used can be varied to provide a product with specific levels of target impurities and concurrently the total level of impurities in the final product required to produce 4N and 5N HPA.

1. A method of preparing high purity alumina from an aluminium chloride liquor,
the method comprising
providing an aluminium chloride liquor comprising aluminium chloride and one or more impurities in solution;
precipitating aluminium chloride hexahydrate solids from the aluminium chloride liquor in one or more crystallisation stage(s), wherein precipitating comprises sparging the liquor with hydrogen chloride gas, such that at least a portion of the one or more impurities remains in the liquor, wherein precipitating aluminium chloride hexahydrate solids further comprises seeding the aluminium chloride liquor in at least one of said crystallisation stage(s);
separating the aluminium chloride hexahydrate solids and the liquor from the one or more crystallisation stage(s); and
processing the separated aluminium chloride hexahydrate solids to form high purity alumina.

2. A method according to claim 1, wherein, prior to precipitating aluminium hexahydrate solids, the aluminium chloride liquor comprises an aluminium concentration in solution of from about 1 g/L to about 100 g/L.

3. A method according to claim 2, wherein, prior to precipitating aluminium hexahydrate solids, the aluminium chloride liquor comprises an aluminium concentration in solution of from about 60 g/L to about 80 g/L.

4. A method according to claim 3, further comprising dissolving a soluble aluminium-bearing material in the aluminium chloride liquor to raise the aluminium concentration in solution to a desired concentration prior to precipitating aluminium hexahydrate solids.

5. A method according to claim 1, comprising two or more crystallisation stages, wherein a first of the two or more crystallisation stages comprises seeding.

6. A method according to claim 1, wherein the aluminium chloride liquor is seeded with an aluminium-bearing seed.

7. A method according to claim 6, wherein the aluminium-bearing seed comprises greater than 95% of aluminium compounds.

8. A method according to claim 6, wherein the aluminium-bearing seed comprises aluminium chloride hexahydrate, and/or high purity alumina.

9. A method according to claim 8, wherein the aluminium chloride hexahydrate seed comprises aluminium chloride hexahydrate solids from one or more crystallisation stages, and/or the high purity alumina seed comprises high purity alumina produced by processing the separated aluminium chloride hexahydrate solids.

10. A method according to any one of the preceding claims, wherein the liquor is seeded with aluminium chloride hexahydrate crystals.

11.-12. (canceled)

13. A method according to claim 1, wherein aluminium chloride hexahydrate solids are precipitated from the aluminium chloride liquor is performed at a temperature of from about 40° C. to about 80° C.

14. A method according to claim 1, comprising precipitating aluminium chloride hexahydrate solids from aluminium chloride liquor in two or more crystallisation stages, wherein separated aluminium chloride hexahydrate solids are digested in water between crystallisation stages to produce the aluminium chloride liquor.

15. A method according to claim 12, wherein the aluminium chloride liquor in a first crystallisation stage has a lower hydrochloric acid concentration than one or more subsequent crystallisation stages.

16. A method according to claim 13, wherein the aluminium chloride liquor in the first crystallisation stage has a hydrochloric acid concentration of up to about 9 M.

17. A method according to claim 14, wherein the aluminium chloride liquor in at least one subsequent crystallisation stage has a hydrochloric acid concentration of at least about 10 M.

18. A method according to any one of claim 12, wherein precipitating aluminium chloride hexahydrate solids in a crystallisation stage comprises the aluminium chloride liquor undergoing two or more precipitation stages, wherein the precipitation stages are in series.

19. A method according to claim 16, wherein aluminium chloride hexahydrate solids precipitated in one precipitation stage are used to seed the liquor of the following precipitation stage in the series of precipitation stages.

20. (canceled)

21. A method according to claim 1, wherein processing the separated chloride hexahydrate solids to form high purity alumina comprises thermally decomposing the separated aluminium chloride hexahydrate solids by heating the separated aluminium chloride hexahydrate solids at a first temperature of from about 200° C. to about 900° C., and calcining the thermally decomposed solids at a second temperature of from about 1000° C. to about 1300° C.

22. A method according to claim 1, wherein the one or more impurities comprise: calcium (Ca), iron (Fe), potassium (K), magnesium (Mg), sodium (Na), phosphorous (P), silicon (Si), titanium (Ti), copper (Cu), molybdenum (Mo), chromium (Cr), gallium (Ga), zinc (Zn) or a combination thereof.

23.-28. (canceled)

29. A system for preparing high purity alumina from an aluminium-bearing material comprising one or more impurities, the system comprising:
an acid digester for digesting the aluminium bearing material to provide an aluminium chloride liquor comprising one or more impurities;
a first crystallisation vessel for receiving the aluminium chloride liquor from the acid digester, and for precipitating aluminium chloride hexahydrate solids by sparging the liquor with hydrogen chloride gas, such that at least a portion of the one or more impurities remains in the liquor, and by seeding the aluminium chloride liquor;
one or more subsequent crystallisation vessels recrystallising the aluminium chloride hexahydrate solids;
separation means associated with each crystallisation vessel for separating formed aluminium chloride hexahydrate from the remaining liquor; and
thermal treatment means for thermally treating the aluminium chloride hexahydrate solids to provide high purity alumina.
